(19) United States
(12) Patent Application Publication
(10) Pub. No.: US 2025/0131675 A1
(43) Pub. Date: Apr. 24, 2025

(54) STICKER SPECIAL EFFECT GENERATION METHOD, ELECTRONIC DEVICE, AND STORAGE MEDIUM

(71) Applicant: Beijing Zitiao Network Technology Co., Ltd., Beijing (CN)

(72) Inventors: Yuwen QIN, Beijing (CN); Chao ZHOU, Beijing (CN); Ziyue WANG, Beijing (CN); Xinming SU, Beijing (CN); Songjia YANG, Beijing (CN); Siyu SHEN, Beijing (CN)

(21) Appl. No.: 18/917,937

(22) Filed: Oct. 16, 2024

(30) Foreign Application Priority Data
Oct. 23, 2023 (CN) 202311378649.2

(51) Int. Cl. G06T 19/20; G06T 7/73

(52) U.S. Cl. CPC G06T 19/20; G06T 7/75; G06T 2207/30201

(57) ABSTRACT

Embodiments of the present disclosure provide a sticker effect generation method and apparatus, an electronic device, and a storage medium. The method includes: displaying an obtained target face model; displaying a selected sticker on the target face model in response to a selection operation for a sticker; determining, in response to an edit operation for the sticker on the target face model, display parameter information about the sticker after the sticker is edited on the target face model, and rendering and displaying the sticker on the target face model based on the display parameter information and a type of the sticker; and generating a target sticker effect object based on the display parameter information about the sticker and the target face model in response to a release operation.

### CROSS-REFERENCE TO RELATED APPLICATION

The present application claims the priority to Chinese Patent Application No. 202311378649.2, filed on Oct. 23, 2023, the entire disclosure of which is incorporated herein by reference as portion of the present application.

### TECHNICAL FIELD

The present disclosure relates to a sticker effect generation method and apparatus, an electronic device, and a storage medium.

### BACKGROUND

With the development of computer technologies, during capture of an image or a video, various effect can be added, including, for example, a facial 3D sticker effect. However, the creation of a 3D sticker effect usually requires real-time generation of an intermediate texture picture for each edit, which results in high performance consumption, and the effect is supported to be created only on a fixed 3D face, which is not flexible enough and also reduces a sticker generation effect.

### SUMMARY

Embodiments of the present disclosure provide at least a sticker effect generation method and apparatus, an electronic device, and a storage medium.

According to a first aspect, an embodiment of the present disclosure provides a sticker effect generation method. The method includes:
displaying an obtained target face model;
displaying a selected sticker on the target face model in response to a selection operation for a sticker;
determining, in response to an edit operation for the sticker on the target face model, display parameter information about the sticker after the sticker is edited on the target face model, and rendering and displaying the sticker on the target face model based on the display parameter information and a type of the sticker; and
generating a target sticker effect object based on the display parameter information about the sticker and the target face model in response to a release operation.

According to a second aspect, an embodiment of the present disclosure further provides a sticker effect generation apparatus. The apparatus includes:
a first display module configured to display an obtained target face model;
a second display module configured to display a selected sticker on the target face model in response to a selection operation for a sticker;
an editing module configured to determine, in response to an edit operation for the sticker on the target face model, display parameter information about the sticker after the sticker is edited on the target face model, and render and display the sticker on the target face model based on the display parameter information and a type of the sticker; and
a release module configured to generate a target sticker effect object based on the display parameter information about the sticker and the target face model in response to a release operation.

According to a third aspect, an optional implementation of the present disclosure further provides an electronic device including a processor and a memory, where the memory stores machine-readable instructions executable by the processor, the processor is configured to execute the machine-readable instructions stored in the memory, and the machine-readable instructions, when executed by the processor, cause the processor to perform the steps in the first aspect described above or in any one of possible implementations of the first aspect.

According to a fourth aspect, an optional implementation of the present disclosure further provides a non-transitory computer-readable storage medium having stored thereon a computer program that, when executed by a processor, causes the steps in the first aspect described above or any one of possible implementations of the first aspect to be implemented.

### BRIEF DESCRIPTION OF DRAWINGS

In order to more clearly illustrate the technical solutions in the embodiments of the present disclosure, the accompanying drawings for describing the embodiments will be briefly described below. The accompanying drawings herein, which are incorporated into and form a part of the description, show the embodiments in line with the present disclosure and are used in conjunction with the description to illustrate the technical solutions of the present disclosure. It should be understood that the following accompanying drawings only show some embodiments of the present disclosure, and therefore should not be considered as a limitation on the scope. For those of ordinary skill in the art, other related accompanying drawings can be derived from these accompanying drawings without creative efforts.

FIG. 1 is a flowchart of a sticker effect generation method according to an embodiment of the present disclosure;

FIG. 2 is a schematic diagram of texture drawing according to an embodiment of the present disclosure;

FIG. 3 is a schematic diagram of calculating an edit box according to an embodiment of the present disclosure;

FIG. 4 is a flowchart of another sticker effect generation method according to an embodiment of the present disclosure;

FIG. 5 is a schematic diagram of a sticker effect generation apparatus according to an embodiment of the present disclosure; and

FIG. 6 is a schematic diagram of an electronic device according to an embodiment of the present disclosure.

### DETAILED DESCRIPTION

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

In order to make the objectives, technical solutions, and advantages of embodiments of the present disclosure clearer, the technical solutions in the embodiments of the present disclosure will be clearly and completely described below with reference to the accompanying drawings in the embodiments of the present disclosure. Apparently, the described embodiments are merely some rather than all of the embodiments of the present disclosure. In general, the components of the embodiments of the present disclosure described and shown herein can be arranged and designed in various configurations. Therefore, the following detailed description of the embodiments of the present disclosure is not intended to limit the scope of protection of the present disclosure, but merely represents selected embodiments of the present disclosure. All other embodiments obtained by those skilled in the art based on the embodiments of the present disclosure without creative efforts shall fall within the scope of protection of the present disclosure.

It has been found through research that, currently, when a facial 3D sticker effect is designed, for each edit operation of a user, for example, an operation of rotating a sticker by 30 degrees, an intermediate texture picture file obtained after the sticker is rotated by 30 degrees needs to be generated in real time, and during the design process, the user usually needs to perform a plurality of edit operations. This method results in high performance consumption, and the user can design the effect only on a fixed face model, which is not flexible enough and reduces the display effect of the designed 3D sticker effect.

Based on the above research, the present disclosure provides a sticker effect generation method, including: displaying an obtained target face model; displaying, a selected sticker on the target face model in response to a selection operation for a sticker; determining, in response to an edit operation for the sticker on the target face model, display parameter information about the sticker after the sticker is edited on the target face model, and rendering and displaying the sticker on the target face model based on the display parameter information and a type of the sticker; and generating a target sticker effect object based on the display parameter information about the sticker and the target face model in response to a release operation. In this way, the sticker is rendered and displayed on the target face model based on the display parameter information that is determined after the edit operation of a user without a need to generate an intermediate texture picture file, which can reduce the performance consumption, and improve the efficiency of designing the target sticker effect object and the display effect of the target sticker effect object.

The defects that exist in the above solution are all obtained by the inventors through practice and careful research. Therefore, the process of discovering the above problem, and the solutions to the above problem that are provided in the present disclosure hereinafter should all be contributions made by the inventors to the present disclosure in the course of the present disclosure.

It should be noted that similar reference signs and letters refer to similar items in the following accompanying drawings. Therefore, once a specific item is defined in one of the accompanying drawings, it need not be further defined and explained in subsequent accompanying drawings.

To facilitate an understanding of this embodiment, a sticker effect generation method disclosed in an embodiment of the present disclosure is first described in detail. An execution body of the sticker effect generation method provided in the embodiment of the present disclosure is generally an electronic device with some computing capabilities. For example, the electronic device includes: a terminal device or a server or another processing device. The terminal device may be a user equipment (UE), a mobile device, a cellular phone, a cordless phone, a personal digital assistant (PDA), a handheld device, a computing device, a vehicle-mounted device, a wearable device, etc. The personal digital assistant is a handheld electronic device, which has some functions of an electronic computer, and may be used to manage personal information, surf the Internet, send and receive e-mails, and so on. The personal digital assistant is generally not equipped with a keyboard, and may also be referred to as a palmtop computer. In some possible implementations, the sticker effect generation method may be implemented by a processor by calling computer-readable instructions stored in a memory.

The sticker effect generation method provided in the embodiment of the present disclosure is described below by using an example in which the execution body is the terminal device.

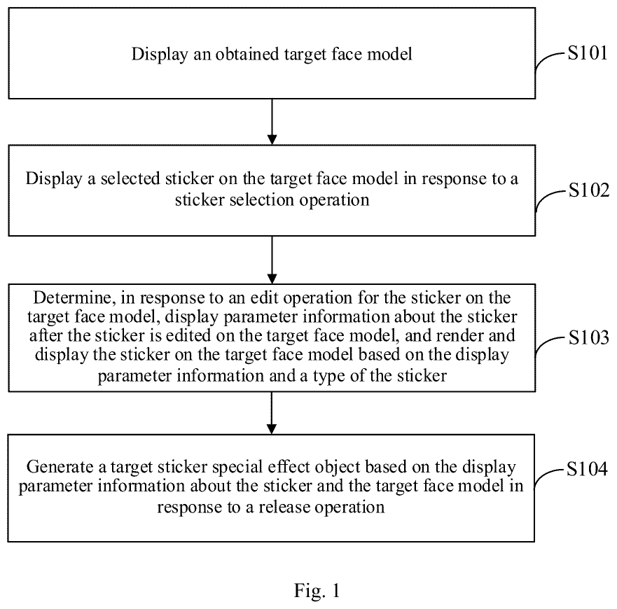

FIG. 1 is a flowchart of a sticker effect generation method according to an embodiment of the present disclosure. The method includes the following steps.

S101: Display an obtained target face model.

In the embodiment of the present disclosure, the method may be applied to a design scenario for a facial 3D sticker effect. For example, by using a design application that is installed on a smartphone, a user may display the target face model in a default interface of the application, and provide a variety of alternative sticker resources below.

Further, the embodiment of the present disclosure provides an implementation for obtaining the target face model, which includes: obtaining the target face model that is captured in response to a face capture instruction; or obtaining the target face model that is selected in response to a face model selection instruction.

In this implementation, the selected target face model may be preset, for which target face model there is a corresponding two-dimensional sticker including a plurality of two-dimensional location points, while for the captured target face model, its corresponding two-dimensional sticker including a plurality of two-dimensional location points may be obtained through calculation after capture of the model. In addition, during capture of the target face model, a viewing frame may be displayed to the user in real time, to facilitate the user in previewing and adjusting the captured target face model.

For example, the user delivers a trigger instruction for capturing the target face model, the viewing frame is displayed to the user in real time, and after the user makes adjustments many times, the target face model is obtained in response to the face capture instruction and is then displayed, and one two-dimensional sticker including a plurality of two-dimensional location points is generated through calculation for the captured target face model.

Based on the above implementation, different target face models may be obtained and displayed, significantly improving the flexibility of designing a target sticker effect, and facilitating an improvement in the display effect of the target sticker effect on different face shapes.

S102: Display a selected sticker on the target face model in response to a selection operation for a sticker.

In this step, when selecting a sticker, the user may select the sticker directly from a preset sticker resource library or import a self-provided sticker resource, or may first select a type of the sticker, and then select the sticker from a resource library corresponding to the selected type of the sticker or import a self-provided sticker resource of the corresponding type. In the embodiment of the present disclosure, the type of the sticker includes any one of the following: a single image, a sequence frame animation, an animation in a graphics interchange format, and a video.

After the selection operation for the sticker, the selected sticker may be displayed at a default initial display location preset on the target face model, for example, the default initial display location may be a right cheek of the target face model, or the selected sticker may be displayed at an appropriate display location that is preliminarily calculated based on a size and shape of the selected sticker.

For example, if the user selects the type of the sticker as the single image, a preset sticker resource library for the single image is displayed to the user. In response to the user selecting a heart-shaped sticker from the preset sticker resource library for the single image, the selected heart-shaped sticker is then displayed at the default initial display location, namely on the right cheek of the target face model.

Based on the above implementation, different types of stickers selected may be directly displayed on the target face model, diversifying the target sticker effect, and significantly improving the efficiency of designing the target sticker effect.

S103: Determine, in response to an edit operation for the sticker on the target face model, display parameter information about the sticker after the sticker is edited on the target face model, and render and display the sticker on the target face model based on the display parameter information and a type of the sticker.

In this step, the user may directly edit the sticker on the target face model, for example, drag, rotate, or zoom in or out the sticker. After the user has edited the sticker, the display parameter information about the sticker after the sticker is edited on the target face model is determined, and the sticker is rendered and displayed on the target face model based on the display parameter information after editing and the type of the sticker. A preset script program may be used to detect the type of the currently edited sticker and render the sticker.

For example, the user drags the sticker from the right cheek location on the target face model to a forehead location thereon, and rotates the sticker by 180 degrees. The above display parameter information after editing is determined. The type of the sticker is determined as a single picture, and the sticker picture is rendered and displayed at the forehead location on the target face model.

Based on the above implementation, instead of operating on the sticker in an edit panel, the sticker can be directly edited on the target face model, improving the visibility of a design process, and improving the design efficiency. In addition, when the sticker is rendered and displayed on the target face model, no intermediate texture picture file needs to be generated, reducing the performance consumption.

S104: Generate a target sticker effect object based on the display parameter information about the sticker and the target face model in response to a release operation.

In this step, when the release operation of the user is received, the target sticker effect object is generated based on the current display parameter information about the sticker and the target face model. For example, the display parameter information may include a display location, a rotation angle, and a size. The released target sticker effect object may be applied to another face and displayed based on the display parameter information at the time of release.

For example, at the time of release, a heart-shaped sticker edited by the user is rotated clockwise by 30 degrees at the forehead location on the target face model, and is zoomed in to a target size. In this case, when the heart-shaped sticker is used by another user, the heart-shaped sticker may be displayed, at a display location, rotation angle, and size corresponding to that at the time of release, on a face model selected by the user.

Further, in the embodiment of the present disclosure, in the case of a plurality of stickers, the target sticker effect object may be generated based on display parameter information about each sticker and the target face model.

Based on the above implementation, the target sticker effect object may be generated based on the display parameter information about the edited sticker and the target face model, significantly improving the display effect of the target sticker effect object.

For the editing process in step S103 above, to further facilitate a more accurate edit operation for the user, the embodiment of the present disclosure provides a possible implementation, which includes: displaying a first edit box for the sticker in response to a click operation for the sticker on the target face model; and receiving the edit operation for the sticker that is performed using the first edit box, where the first edit box has a preset edit control displayed at an associated location.

In the above implementation, a sticker selected by the user is determined by means of the click operation of the user for the sticker, and the first edit box is displayed around the sticker. In this case, an edit operation, for example, dragging, rotating and zooming in or out, of the user for the first edit box may be received to edit the corresponding sticker. In addition, the above edit box has the preset edit control, such as a closing control and a rotating control, displayed at the associated location, and the user may alternatively implement the edit operation for the sticker by using the above preset edit control.

Based on the above implementation, implementing the edit operation for the sticker by using the first edit box and/or the preset edit control can significantly improve the accuracy of the edit operation of the user, particularly when there are a plurality of stickers on the target face model, the sticker that is currently being edited may be intuitively reflected by using different edit boxes, thereby reducing the probability of mis-operations, and improving the efficiency and accuracy of designing a sticker effect.

Next, for a texture drawing process during editing of the sticker in the embodiment of the present disclosure, specifically, determining the display parameter information about the sticker after the sticker is edited on the target face model includes:
1) determining a target transformation matrix corresponding to the edit operation based on the edit operation and preset initial display parameter information;
2) rendering the sticker on a reference texture object based on the target transformation matrix, to obtain an updated target texture object, where there is a location binding relationship between the reference texture object and the target face model; and
3) determining, based on the target texture object and the location binding relationship, the display parameter information about the sticker after the sticker is edited on the target face model.

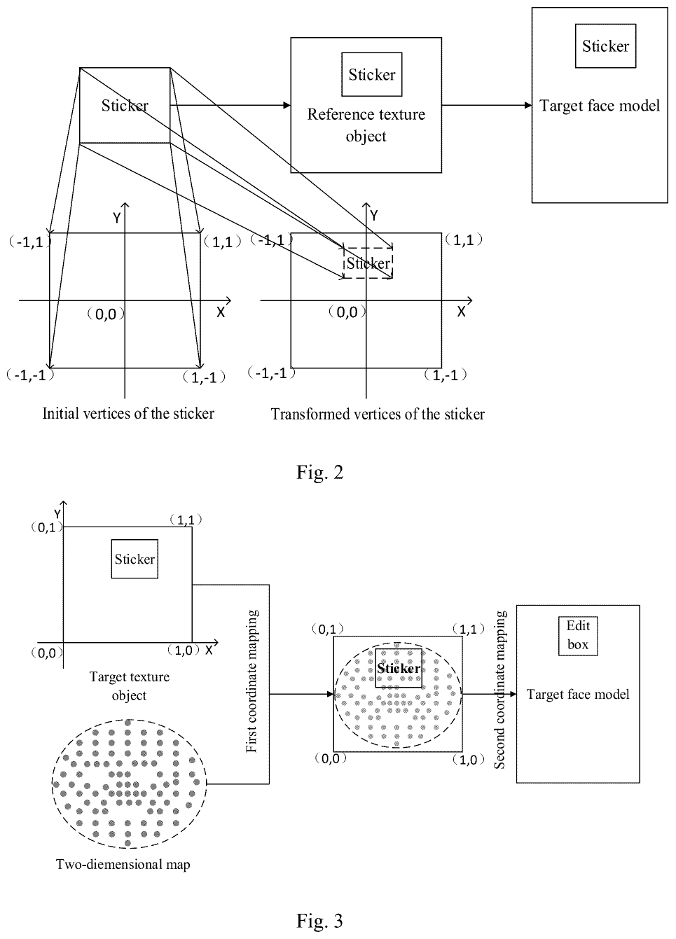

In the above implementation, the edit operation of the user may be recorded by using the target transformation matrix, each edit operation of the user corresponds to a change in the target transformation matrix, and the sticker is rendered on the reference texture object based on the target transformation matrix. Reference may be made to FIG. 2. FIG. 2 is a schematic diagram of texture drawing according to an embodiment of the present disclosure.

As shown in FIG. 2, in a two-dimensional coordinate system with (0, 0) as an origin that is formed by an X-axis and a Y-axis, initial vertices of a sticker correspond to four locations. Specifically, an upper right vertex is at the location (1, 1), an upper left vertex is at the location (−1, 1), a lower left vertex is at the location (−1, −1), and a lower right vertex is at the location (1, −1). Transformed vertices of the sticker are located inside a region formed by the initial vertices of the sticker, which is equivalent to zooming out the sticker.

As shown in FIG. 2, after being edited, the sticker is rendered on a reference texture object, and then display parameter information about the sticker after the sticker is edited on the target face model is determined.

In the embodiment of the present disclosure, the above reference texture object may be a render texture (RT). The reference texture object is adjusted to have the same size as that of a two-dimensional map corresponding to the target face model, and then a target transformation matrix corresponding to the sticker is transmitted to a shader program, to obtain transformed coordinates of the sticker. The sticker is rendered on the reference texture object, to obtain an updated target texture object. Since the reference texture object exists only in a running memory of a system and is not saved locally, no intermediate image file is generated, which can significantly improve the rendering efficiency. The display parameter information about the sticker after the sticker is edited on the target face model may be determined based on a location binding relationship between the updated target texture object and the target face model, where the above location binding relationship may be preset. Then, the sticker may be rendered and displayed on the target face model.

Based on the above implementation, the rendering efficiency can be significantly improved by rendering the sticker on the reference texture object to obtain the updated target texture object without the need to generate the intermediate image file, and the display parameter information after editing can be accurately determined based on the location binding relationship between the target texture object and the target face model, which in turn improves the accuracy of rendering and displaying the sticker on the target face model.

Further, when the user edits the sticker, the edited sticker may be rendered in real time, and an edit box may also be updated in real time based on the edited sticker. In this case, the present disclosure further provides a possible implementation for the edit box, which specifically includes:
1) based on a first coordinate mapping relationship between a two-dimensional map corresponding to the target face model and the target texture object, determining a plurality of two-dimensional location points corresponding to the sticker in the two-dimensional map;
2) based on a second coordinate mapping relationship between the target face model and the two-dimensional map and the plurality of two-dimensional location points, determining a plurality of three-dimensional location points corresponding to the sticker in the target face model; and
3) based on the plurality of three-dimensional location points, determining a second edit box that is able to include the plurality of three-dimensional location points and meet a preset area screening condition, and updating and displaying the second edit box for the sticker.

In the above implementation, the two-dimensional map corresponding to the target face model and the two-dimensional location points in the two-dimensional map are all preset. Referring to FIG. 3, FIG. 3 is a schematic diagram of calculating an edit box according to an embodiment of the present disclosure. First, first coordinate mapping may be implemented based on the first coordinate mapping relationship between the two-dimensional map corresponding to the target face model and the target texture object, to determine a spatial extent occupied by the above target texture object in the two-dimensional map, and the plurality of two-dimensional location points corresponding to the sticker in the two-dimensional map may be determined based on the occupied spatial extent. As shown in FIG. 3, in the two-dimensional coordinate system formed by the X-axis and the Y-axis, the target texture object corresponds to four vertices (1, 1), (0, 1), (0, 0), and (1, 0), and the target texture object includes the sticker. Then, second coordinate mapping may be implemented based on the second coordinate mapping relationship between the target face model and the two-dimensional map, to implement transformation from a two-dimensional sticker to a three-dimensional target face model, such that the three-dimensional location points corresponding to the plurality of two-dimensional location points are determined. Finally, based on the determined plurality of three-dimensional location points, the second edit box that can include the plurality of three-dimensional location points and meet the preset area screening condition is determined as an edit box obtained through calculation. The preset area screening condition may be a minimum bounding rectangle including a plurality of three-dimensional location points. In this way, the performance consumption for calculating the edit box can be reduced, and the accuracy of the edit box can be improved. After the second edit box is determined, the second edit box for the sticker is updated and displayed.

When the second edit box for the sticker is updated and displayed, the embodiment of the present disclosure further provides a possible implementation, including: obtaining a display coordinate system of a display apparatus for displaying the target face model; determining display parameter information for the target face model in the display apparatus based on a third coordinate mapping relationship between the display coordinate system and a three-dimensional coordinate system corresponding to the target face model; and updating and displaying the target face model. In this way, the target face model and the corresponding sticker and edit box can be accurately displayed by using the display apparatus.

Based on the above implementation, by means of the first coordinate mapping relationship between the two-dimensional map corresponding to the target face model and the target texture object and the second coordinate mapping relationship between the target face model and the two-dimensional map, transformation from the two-dimensional location points to the three-dimensional location points may be accurately implemented, and the location, size and rotation angle of the edit box may all change as the sticker changes, thereby improving the fit degree between the edit box and the corresponding sticker, improving the accuracy of displaying the edit box, and facilitating an improvement in the efficiency and accuracy of editing a sticker effect by the user.

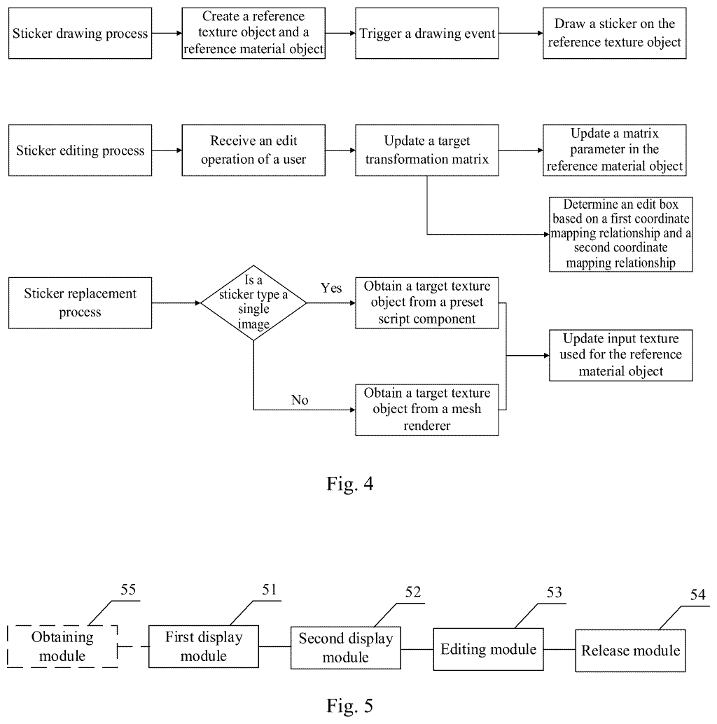

Descriptions are made below in a specific application scenario. FIG. 4 is a flowchart of another sticker effect generation method according to an embodiment of the present disclosure. Designing a target sticker effect object mainly includes the following processes.

### 1) Sticker Drawing Process

In the embodiment of the present disclosure, for example, after a sticker effect generation function is triggered, initialization may be first performed. For example, a reference texture object (Render Texture), a reference material object (Bilt Material) required for drawing, and a command buffer (Command Buffer) instance are initially created, and a reference relationship between the above three objects is established. In addition, a face material object for drawing the target sticker effect object is initially created.

Subsequently, a target face model may be displayed, and a sticker may be selected and then displayed on the target face model. In the embodiment of the present disclosure, when the target face model and the sticker are rendered and displayed, a possible implementation is specifically provided. For example, a rendering frame cycle may be set, and a drawing event is triggered based on the rendering frame cycle. On each drawing event, a drawing action of the Command Buffer is triggered, and the Command Buffer instance invokes the Render Texture and the Bilt Material to perform drawing corresponding to current values, to draw the sticker on the reference texture object, so as to generate a target texture object.

Further, rendering and drawing are performed based on the target texture object and the face material object, to implement rendering and display of the sticker on the target face model.

Based on the above implementation, the sticker may be accurately rendered on the target face model, facilitating an improvement in the display effect of the target sticker effect object.

### 2) Sticker Editing Process

In the embodiment of the present disclosure, an edit operation for the sticker on the target face model may further be supported. In each edit operation, a corresponding target transformation matrix is determined based on initial display parameters for the sticker. For example, the initial display parameters include initial location coordinates, a size, and a rotation angle. After the edit operation of a user for the sticker is received, the above target transformation matrix is updated. The edit operation includes at least selecting, dragging, zooming in or out, rotating, etc.

Further, a matrix parameter in the reference material object is updated based on the updated target transformation matrix, and an edit box is determined based on a first coordinate mapping relationship and a second coordinate mapping relationship, including: first determining display parameter information of the edit box, and then displaying the edit box in the target face model based on the display parameter information, so that the sticker can be edited based on the edit box.

The first coordinate mapping relationship means a coordinate mapping relationship between a two-dimensional map corresponding to the target face model and the target texture object. The second coordinate mapping relationship means a coordinate mapping relationship between the target face model and the two-dimensional map.

Based on the above implementation, an updated map and a corresponding edit box may be rendered in real time based on the edit operation of the user, improving the fit degree between the edit box and the sticker, and thus improving the accuracy and efficiency of designing a sticker effect.

### 3) Sticker Replacement Process

In the embodiment of the present disclosure, each time the reference texture object is updated, a sticker type of a currently used sticker is first checked, for example, by determining whether the sticker type is a single image. If the sticker type is a single image, a target texture object is obtained from a preset script component. If the sticker type is not a single image, a real-time target texture object is obtained from a mesh renderer.

Further, input texture used for the reference material object is updated based on the obtained target texture object, that is, the input texture used for the reference material object is updated to texture corresponding to a sticker selected by the user.

Based on the above implementation, different types of stickers may be rendered and displayed on the target face model, diversifying a target sticker object.

Those skilled in the art can understand that, in the above methods of the specific implementations, the order in which the steps are written does not imply a strict execution order, and does not constitute any limitation on the implementation process. The specific execution order of the steps should be determined by their functions and possible internal logics.

Based on the same inventive concept, a sticker effect generation apparatus corresponding to the sticker effect generation method is further provided in an embodiment of the present disclosure. Because the principle of solving the problems by the apparatus in the embodiment of the present disclosure is similar to that of the sticker effect generation methods described above in the embodiments of the present disclosure, for the implementation of the apparatus, reference may be made to the implementations of the methods, and the repetition is not described herein again.

FIG. 5 is a schematic diagram of a sticker effect generation apparatus according to an embodiment of the present disclosure. The apparatus includes:
a first display module 51 configured to display an obtained target face model;
a second display module 52 configured to display a selected sticker on the target face model in response to a selection operation for a sticker;
an editing module 53 configured to determine, in response to an edit operation for the sticker on the target face model, display parameter information about the sticker after the sticker is edited on the target face model, and render and display the sticker on the target face model based on the display parameter information and a type of the sticker; and
a release module 54 configured to generate a target sticker effect object based on the display parameter information about the sticker and the target face model in response to a release operation.

In an optional implementation, the apparatus further includes an obtaining module 55. When obtaining the target face model, the obtaining module 55 is configured to:
obtain the target face model that is captured in response to a face capture instruction; or
obtain the target face model that is selected in response to a face model selection instruction.

In an optional implementation, when performing the edit operation for the sticker on the target face model, the editing module 53 is configured to:
display a first edit box for the sticker in response to a click operation for the sticker on the target face model; and
receive the edit operation for the sticker that is performed using the first edit box, where the first edit box has a preset edit control displayed at an associated location.

In an optional implementation, when determining the display parameter information about the sticker after the sticker is edited on the target face model, the editing module 53 is configured to:
determine a target transformation matrix corresponding to the edit operation based on the edit operation and preset initial display parameter information;
render the sticker on a reference texture object based on the target transformation matrix, to obtain an updated target texture object, where there is a location binding relationship between the reference texture object and the target face model; and
determine, based on the target texture object and the location binding relationship, the display parameter information about the sticker after the sticker is edited on the target face model.

In an optional implementation, the editing module 53 is further configured to:
based on a first coordinate mapping relationship between a two-dimensional map corresponding to the target face model and the target texture object, determine a plurality of two-dimensional location points corresponding to the sticker in the two-dimensional map;
based on a second coordinate mapping relationship between the target face model and the two-dimensional map and the plurality of two-dimensional location points, determine a plurality of three-dimensional location points corresponding to the sticker in the target face model; and
based on the plurality of three-dimensional location points, determine a second edit box that is able to include the plurality of three-dimensional location points and meet a preset area screening condition, and update and display the second edit box for the sticker.

In an optional implementation, when generating the target sticker effect object based on the display parameter information about the sticker and the target face model, the release module 54 is configured to:
in the case of a plurality of stickers, generate the target sticker effect object based on display parameter information about each of the stickers and the target face model.

In an optional implementation, the type of the sticker includes any one of the following: a single image, a sequence frame animation, an animation in a graphics interchange format, and a video.

For the description of the processing processes of various modules in the apparatus, and the interaction processes between the modules, reference may be made to the related description in the above method embodiments, and details are not described herein again.

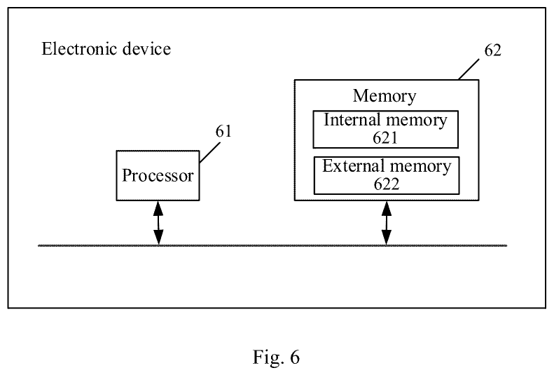

An embodiment of the present disclosure further provides an electronic device. FIG. 6 is a schematic diagram of a structure of an electronic device according to an embodiment of the present disclosure. The electronic device includes:
a processor 61 and a memory 62. The memory 62 stores machine-readable instructions executable by the processor 61, the processor 61 is configured to execute the machine-readable instructions stored in the memory 62, and the machine-readable instructions, when executed by the processor 61, cause the processor 61 to:
display an obtained target face model;
display a selected sticker on the target face model in response to a selection operation for a sticker;
determine, in response to an edit operation for the sticker on the target face model, display parameter information about the sticker after the sticker is edited on the target face model, and render and display the sticker on the target face model based on the display parameter information and a type of the sticker; and
generate a target sticker effect object based on the display parameter information about the sticker and the target face model in response to a release operation.

In an optional implementation, when obtaining the target face model, the processor 61 is configured to:
obtain the target face model that is captured in response to a face capture instruction; or
obtain the target face model that is selected in response to a face model selection instruction.

In an optional implementation, when performing the edit operation for the sticker on the target face model, the processor 61 is configured to:
display a first edit box for the sticker in response to a click operation for the sticker on the target face model; and
receive the edit operation for the sticker that is performed using the first edit box, where the first edit box has a preset edit control displayed at an associated location.

In an optional implementation, when determining the display parameter information about the sticker after the sticker is edited on the target face model, the processor 61 is configured to:
determine a target transformation matrix corresponding to the edit operation based on the edit operation and preset initial display parameter information;
render the sticker on a reference texture object based on the target transformation matrix, to obtain an updated target texture object, where there is a location binding relationship between the reference texture object and the target face model; and
determine, based on the target texture object and the location binding relationship, the display parameter information about the sticker after the sticker is edited on the target face model.

In an optional implementation, the processor 61 is further configured to:
based on a first coordinate mapping relationship between a two-dimensional map corresponding to the target face model and the target texture object, determine a plurality of two-dimensional location points corresponding to the sticker in the two-dimensional map;
based on a second coordinate mapping relationship between the target face model and the two-dimensional map and the plurality of two-dimensional location points, determine a plurality of three-dimensional location points corresponding to the sticker in the target face model; and
based on the plurality of three-dimensional location points, determine a second edit box that is able to include the plurality of three-dimensional location points and meet a preset area screening condition, and update and display the second edit box for the sticker.

In an optional implementation, when generating the target sticker effect object based on the display parameter information about the sticker and the target face model, the processor 61 is configured to:
in the case of a plurality of stickers, generate the target sticker effect object based on display parameter information about each of the stickers and the target face model.

In an optional implementation, the type of the sticker includes any one of the following: a single image, a sequence frame animation, an animation in a graphics interchange format, and a video.

The above memory 62 includes an internal memory 621 and an external memory 622. The internal memory 621 here is also referred to as a primary memory, which is configured to temporarily store operation data of the processor 61, and data exchanged with the external memory 622 such as a hard disk. The processor 61 exchanges data with the external memory 622 through the internal memory 621.

For the specific execution process of the above instructions, reference may be made to the steps of the sticker effect generation method described in the embodiments of the present disclosure, and details are not repeated herein.

An embodiment of the present disclosure further provides a computer-readable storage medium having stored thereon a computer program that, when run by a processor, causes the steps of the sticker effect generation method described in the above method embodiments to be performed. The storage medium may be a volatile or non-volatile computer-readable storage medium.

An embodiment of the present disclosure further provides a computer program product carrying program code, where instructions included in the program code can be used to perform the steps of the sticker effect generation method described in the above method embodiments. For details, reference may be made to the above method embodiments, and details are not repeated herein.

The above computer program product may be implemented in the form of hardware, software or a combination thereof. In an optional embodiment, the computer program product is specifically embodied as a computer storage medium. In another optional embodiment, the computer program product is specifically embodied as a software product, such as a software development kit (SDK).

It can be clearly understood by those skilled in the art that, for convenience and brevity of description, for the specific operation processes of the system and apparatus described above, reference may be made to the corresponding processes in the foregoing method embodiments, and details are not repeated herein. In the several embodiments provided in the present disclosure, it should be understood that the disclosed system, apparatus, and method may be implemented in other manners. The apparatus embodiment described above is merely an example. For example, the unit division is merely logical function division and may be other division during actual implementation. For another example, a plurality of units or components may be combined or integrated into another system, or some features may be omitted or not implemented. In addition, the displayed or discussed mutual couplings, direct couplings, or communication connections may be implemented through some communication interfaces. The indirect couplings or communication connections between the apparatuses or units may be implemented in electrical, mechanical, or other forms.

The units described as separate parts may or may not be physically separate, and parts displayed as units may or may not be physical units, and may be located at one position, or may be distributed on a plurality of network units. Some or all of the units may be selected according to actual needs to achieve the objectives of the solutions of the embodiments.

In addition, various functional units in the various embodiments of the present disclosure may be integrated into one processing unit, each of the units may exist alone physically, or two or more units may be integrated into one unit.

If the functions are implemented in the form of a software functional unit and sold or used as an independent product, the functions may be stored in a non-volatile computer-readable storage medium executable by a processor. Based on such an understanding, the technical solutions of the present disclosure essentially or some of the technical solutions may be implemented in the form of a software product. The computer software product is stored in a storage medium and includes several instructions for instructing an electronic device (which may be a personal computer, a server, a network device, etc.) to perform all or some of the steps of the methods described in the embodiments of the present disclosure. Moreover, the foregoing storage medium includes a USB flash drive, a removable hard disk, a read-only memory (ROM), a random access memory (RAM), a magnetic disk, an optical disc, or other various media that can store program code.

It should be finally noted that the embodiments described above are merely specific implementations of the present disclosure, and used for illustrating rather than limiting the technical solutions of the present disclosure, and the scope of protection of the present disclosure is not limited thereto. Although the present disclosure has been described in detail with reference to the foregoing embodiments, those of ordinary skill in the art should understand that, within the technical scope disclosed in the present disclosure, any person skilled in the art could still modify the technical solutions specified in the foregoing embodiments, or readily figure out any variation thereof, or make equivalent substitution to some of the technical features thereof. However, these modifications, variations, or substitutions do not make the essence of the corresponding technical solutions depart from the spirit and scope of the technical solutions of the embodiments of the present disclosure, and shall fall within the scope of protection of the present disclosure. Therefore, the scope of protection of the present disclosure shall be subject to the scope of protection of the claims.

1. A sticker effect generation method, comprising:
displaying an obtained target face model;
displaying a selected sticker on the target face model in response to a selection operation for a sticker;
determining, in response to an edit operation for the sticker on the target face model, display parameter information about the sticker after the sticker is edited on the target face model, and rendering and displaying the sticker on the target face model based on the display parameter information and a type of the sticker; and
generating a target sticker effect object based on the display parameter information about the sticker and the target face model in response to a release operation.

2. The method according to claim 1, wherein obtaining the target face model comprises:
obtaining the target face model that is captured in response to a face capture instruction; or
obtaining the target face model that is selected in response to a face model selection instruction.

3. The method according to claim 1, wherein the edit operation for the sticker on the target face model comprises:
displaying a first edit box for the sticker in response to a click operation for the sticker on the target face model; and
receiving the edit operation for the sticker that is performed using the first edit box, wherein the first edit box has a preset edit control displayed at an associated location.

4. The method according to claim 2, wherein the edit operation for the sticker on the target face model comprises:
displaying a first edit box for the sticker in response to a click operation for the sticker on the target face model; and
receiving the edit operation for the sticker that is performed using the first edit box, wherein the first edit box has a preset edit control displayed at an associated location.

5. The method according to claim 1, wherein the determining display parameter information about the sticker after the sticker is edited on the target face model comprises:
determining a target transformation matrix corresponding to the edit operation based on the edit operation and preset initial display parameter information;
rendering the sticker on a reference texture object based on the target transformation matrix, to obtain an updated target texture object, wherein there is a location binding relationship between the reference texture object and the target face model; and
determining, based on the target texture object and the location binding relationship, the display parameter information about the sticker after the sticker is edited on the target face model.

6. The method according to claim 2, wherein the determining display parameter information about the sticker after the sticker is edited on the target face model comprises:
determining a target transformation matrix corresponding to the edit operation based on the edit operation and preset initial display parameter information;
rendering the sticker on a reference texture object based on the target transformation matrix, to obtain an updated target texture object, wherein there is a location binding relationship between the reference texture object and the target face model; and
determining, based on the target texture object and the location binding relationship, the display parameter information about the sticker after the sticker is edited on the target face model.

7. The method according to claim 3, wherein the determining display parameter information about the sticker after the sticker is edited on the target face model comprises:
determining a target transformation matrix corresponding to the edit operation based on the edit operation and preset initial display parameter information;
rendering the sticker on a reference texture object based on the target transformation matrix, to obtain an updated target texture object, wherein there is a location binding relationship between the reference texture object and the target face model; and
determining, based on the target texture object and the location binding relationship, the display parameter information about the sticker after the sticker is edited on the target face model.

8. The method according to claim 4, wherein the determining display parameter information about the sticker after the sticker is edited on the target face model comprises:
determining a target transformation matrix corresponding to the edit operation based on the edit operation and preset initial display parameter information;
rendering the sticker on a reference texture object based on the target transformation matrix, to obtain an updated target texture object, wherein there is a location binding relationship between the reference texture object and the target face model; and
determining, based on the target texture object and the location binding relationship, the display parameter information about the sticker after the sticker is edited on the target face model.

9. The method according to claim 5, further comprising:
based on a first coordinate mapping relationship between a two-dimensional map corresponding to the target face model and the target texture object, determining a plurality of two-dimensional location points corresponding to the sticker in the two-dimensional map;
based on a second coordinate mapping relationship between the target face model and the two-dimensional map and the plurality of two-dimensional location points, determining a plurality of three-dimensional location points corresponding to the sticker in the target face model; and
based on the plurality of three-dimensional location points, determining a second edit box that is able to comprise the plurality of three-dimensional location points and meet a preset area screening condition, and updating and displaying the second edit box for the sticker.

10. The method according to claim 6, further comprising:
based on a first coordinate mapping relationship between a two-dimensional map corresponding to the target face model and the target texture object, determining a plurality of two-dimensional location points corresponding to the sticker in the two-dimensional map;
based on a second coordinate mapping relationship between the target face model and the two-dimensional map and the plurality of two-dimensional location points, determining a plurality of three-dimensional location points corresponding to the sticker in the target face model; and
based on the plurality of three-dimensional location points, determining a second edit box that is able to comprise the plurality of three-dimensional location points and meet a preset area screening condition, and updating and displaying the second edit box for the sticker.

11. The method according to claim 7, further comprising:
based on a first coordinate mapping relationship between a two-dimensional map corresponding to the target face model and the target texture object, determining a plurality of two-dimensional location points corresponding to the sticker in the two-dimensional map;
based on a second coordinate mapping relationship between the target face model and the two-dimensional map and the plurality of two-dimensional location points, determining a plurality of three-dimensional location points corresponding to the sticker in the target face model; and
based on the plurality of three-dimensional location points, determining a second edit box that is able to comprise the plurality of three-dimensional location points and meet a preset area screening condition, and updating and displaying the second edit box for the sticker.

12. The method according to claim 8, further comprising:
based on a first coordinate mapping relationship between a two-dimensional map corresponding to the target face model and the target texture object, determining a plurality of two-dimensional location points corresponding to the sticker in the two-dimensional map;
based on a second coordinate mapping relationship between the target face model and the two-dimensional map and the plurality of two-dimensional location points, determining a plurality of three-dimensional location points corresponding to the sticker in the target face model; and
based on the plurality of three-dimensional location points, determining a second edit box that is able to comprise the plurality of three-dimensional location points and meet a preset area screening condition, and updating and displaying the second edit box for the sticker.

13. The method according to claim 1, wherein the generating a target sticker effect object based on the display parameter information about the sticker and the target face model comprises:
in the case of a plurality of stickers, generating the target sticker effect object based on display parameter information about each of the stickers and the target face model.

14. The method according to claim 1, wherein the type of the sticker comprises any one of the following: a single image, a sequence frame animation, an animation in a graphics interchange format, and a video.

15. An electronic device, comprising at least one processor and at least one memory, wherein the memory stores machine-readable instructions executable by the processor, the processor is configured to execute the machine-readable instructions stored in the memory, the machine-readable instructions, when executed by the processor, cause the processor to perform a sticker effect generation method, and the sticker effect generation method comprises:
displaying an obtained target face model;
displaying a selected sticker on the target face model in response to a selection operation for a sticker;
determining, in response to an edit operation for the sticker on the target face model, display parameter information about the sticker after the sticker is edited on the target face model, and rendering and displaying the sticker on the target face model based on the display parameter information and a type of the sticker; and
generating a target sticker effect object based on the display parameter information about the sticker and the target face model in response to a release operation.

16. The electronic device according to claim 15, wherein obtaining the target face model comprises:
obtaining the target face model that is captured in response to a face capture instruction; or obtaining the target face model that is selected in response to a face model selection instruction.

17. The electronic device according to claim 15, wherein the edit operation for the sticker on the target face model comprises:
displaying a first edit box for the sticker in response to a click operation for the sticker on the target face model; and
receiving the edit operation for the sticker that is performed using the first edit box, wherein the first edit box has a preset edit control displayed at an associated location.

18. The electronic device according to claim 15, wherein the determining display parameter information about the sticker after the sticker is edited on the target face model comprises:
determining a target transformation matrix corresponding to the edit operation based on the edit operation and preset initial display parameter information;
rendering the sticker on a reference texture object based on the target transformation matrix, to obtain an updated target texture object, wherein there is a location binding relationship between the reference texture object and the target face model; and
determining, based on the target texture object and the location binding relationship, the display parameter information about the sticker after the sticker is edited on the target face model.

19. The electronic device according to claim 18, wherein the sticker effect generation method further comprises:
based on a first coordinate mapping relationship between a two-dimensional map corresponding to the target face model and the target texture object, determining a plurality of two-dimensional location points corresponding to the sticker in the two-dimensional map;
based on a second coordinate mapping relationship between the target face model and the two-dimensional map and the plurality of two-dimensional location points, determining a plurality of three-dimensional location points corresponding to the sticker in the target face model; and
based on the plurality of three-dimensional location points, determining a second edit box that is able to comprise the plurality of three-dimensional location points and meet a preset area screening condition, and updating and displaying the second edit box for the sticker.

20. A non-transitory computer-readable storage medium having a computer program stored thereon, wherein when the computer program is executed by a processor, a sticker effect generation method is implemented, and the sticker effect generation method comprises:
displaying an obtained target face model;
displaying a selected sticker on the target face model in response to a selection operation for a sticker;
determining, in response to an edit operation for the sticker on the target face model, display parameter information about the sticker after the sticker is edited on the target face model, and rendering and displaying the sticker on the target face model based on the display parameter information and a type of the sticker; and
generating a target sticker effect object based on the display parameter information about the sticker and the target face model in response to a release operation.
